(19) United States
(12) Patent Application Publication
(10) Pub. No.: US 2007/0022056 A1
(43) Pub. Date: Jan. 25, 2007

(54) Anti-piracy method for digital works

(76) Inventor: Dino Scorziello, Akron, OH (US)

Correspondence Address: DINO SCORZIELLO, 2037 WILMICH DR, AKRON, OH, 44319, US

(21) Appl. No.: 11/187,101

(22) Filed: Jul. 23, 2005

(51) Int. Cl. G06Q 99/00; G06Q 30/00

(52) U.S. Cl. 705/52; 705/14

(57) ABSTRACT

Executable Media files (10) consisting of media player and/or display software (20), advertisement (30), advertisement identifier (35), digital work (40), work identifier (45), permissive (50), use log generator (60) and communications utility (70) are created and distributed to consumers (130) for free to subvert the incentive to profit from the piracy of digital works. When started, the Executable Media file (10) initiates the media player and/or display software (20), and plays and/or displays the advertisement (30). The permissive (50) checks to ensure the advertisement (30) was played and/or displayed before granting access to the work (40). When access to the work is granted, the use log generator (60) creates a use log (140) containing the advertisement identifier (35) and the work identifier (45). The communications utility (70) conveys the use log (140) to an auditor (110) that then transfers money (160) from the marketer (120) to the digital rights owner (100) in the form of royalty payments (170).

### CROSS-REFERENCE TO RELATED APPLICATIONS

Not applicable.

### BACKGROUND

1. Field of Invention

This invention relates to a method and system for the distribution and use of copyrighted digital works. Specifically this invention allows people to use digital works that are paid for by advertisers, thus subverting the incentive to profit from the piracy of digital works.

2. Description of Prior Art

It is possible for people with very few computer skills to be able to copy and distribute digital copyrighted works globally. Currently, digital rights owners use encryption, licensing schemes and severe legislative penalties to deter people from pirating or possessing pirated works. However, readily available high-powered computers and the global prevalence of the Internet have made it possible for pirates to operate from outside the enforcement jurisdiction of most countries. Filing legal actions against pirates in foreign countries that do not recognize copyright treaties is futile, and the pirate continues unimpeded. Enforcing copyright laws in developing nations is also difficult because pirates help the local economy causing the political support for legal action to be negated.

Furthermore, people skilled in the art are able to decrypt encrypted works or forge digital licenses and create copies of the work for distribution. Encryption and digital licenses only buys a digital rights owner time. If a dedicated pirate perceives that he/she can earn a profit from selling a pirated copy of a work then, eventually they will defeat the encryption or digital license. Again, people who do this from countries that do not recognize a copyright treaty are immune from legal action.

The previous art focuses on encryption, digital watermarks and various licensing schemes to protect the copyrights of digital works all of which can be defeated given enough time and resources. However, the art does not address the root cause of piracy, namely the ability to make a profit from someone else's work and property. Consequently, the piracy of digital works continues unabated. Therefore, it is necessary to establish a new system for protecting digital rights owners from piracy. This system should appeal to price sensitive consumers and provide users little encumbrance when using a digital work, while also ensuring that digital rights owners are compensated for the use of any copies of their works that are distributed to others.

### SUMMARY

In accordance with the present invention, an anti-piracy method for digital works consists of, creating Executable Media files that contain advertisement(s), digital work(s), the play and/or display software and the communications method are all encoded into one Executable Media file that can be freely distributed to users via e-mail and the Internet. Since advertisements pay for the use of the work(s), consumers can use the work(s) for free, thus subverting the incentive to profit from the piracy of digital works.

### OBJECTS AND ADVANTAGES

Accordingly, several objects and advantages of my invention are:
(a) to reduce or eliminate any monetary incentives professional pirates have when pirating a digital work;
(b) the ability to provide free high quality digital works to consumers;
(c) to ensure digital rights owners using my invention are compensated for the use of their works;
(d) to allow consumers to distribute digital works using my invention freely and without hindrance and still ensure digital rights owners are compensated for the use of their works;
(e) to allow advertisers and marketers to reach wider audiences geographically;
(f) to allow advertisers and marketers to target their desired demographic audience more precisely;
(g) to provide a medium in which advertisements must be seen or heard before the copyrighted work is used.
(h) to increase the value of a digital rights owner's catalog of works.
(i) to create a revenue stream for copyright owners who's original works are analog but can be converted to digital form.
   Still further objects and advantages will become apparent from a consideration of the ensuing description and drawings.

### DRAWING FIGURES

FIG. 1 shows the constituents of an Executable Media file.

FIG. 2 graphically describes how a digital rights owner is compensated for use of his/her work after it is encoded into an Executable Media file.

FIG. 3 shows the constituents of a One-Use Executable Media file.

### REFERENCE NUMERALS IN DRAWINGS

10—Executable Media file (EMF)
20—Media Player and/or Display Software
25—Database
30—Advertisement
35—Advertisement Identifier
40—Digital Work (Work)
45—Work Identifier
50—Permissive
60—Use Log Generator
70—Communications Utility
100—Digital Rights Owner
110—Auditor
120—Marketer
130—Consumer
140—Use Log
150—Download
155—Copy
160—Money
170—Royalty Payments
200—One-Use Executable Media file
205—Self-Deletion Utility
215—Compare
220—Server

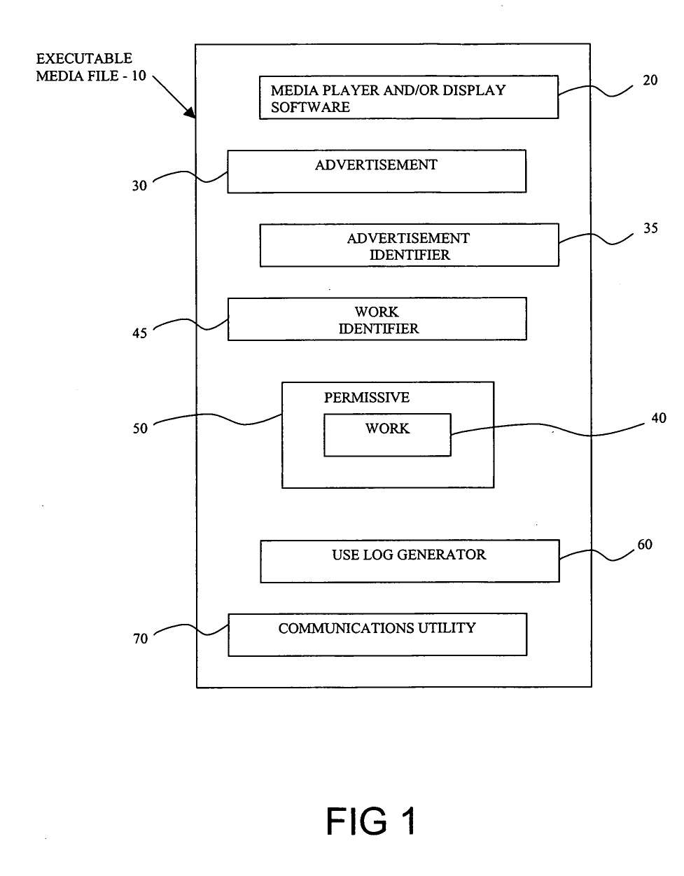

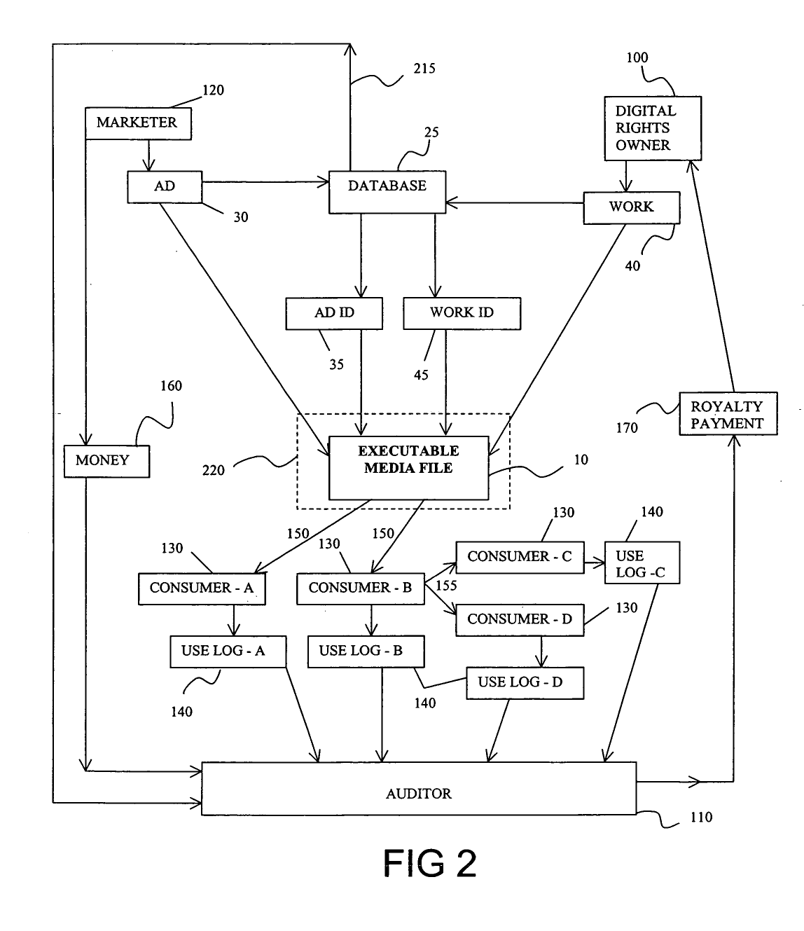

### DESCRIPTION—FIGS. 1 and 2—PREFERRED EMBODIMENT

FIG. 1 shows the constituent components of an Executable Media file 10. The file consists of a media player and/or display software 20. The EMF also contains an advertisement 30 and a digital work 40. Both are data that can be interpreted by the media player and/or display software 20. The advertisement 30 can be, but are not limited to, text, pictures, audible files, video files or any combination of the aforementioned. Typical digital works 40 include music, songs, pictures, stories, novels, movies, shows, video/computer games, software applications or any combination of the aforementioned. The media player and/or display software 20 is selected to be compatible with the advertisement 30 and work 40 format used for each EMF 10.

The permissive 50 is a conditional statement in the programming source code of the EMF. It can consist of, but is not limited to a logic check, a mathematical check or a time check. The use log generator 60 is a software subroutine consisting of instructions needed to generate and save a data file. The advertisement identifier 35 is an alphanumeric character string associated with a unique advertisement. The work identifier 45 is an alphanumeric character string associated with a unique work.

The communication utility 70 will normally be a software subroutine that initiates an existing communication program on the user's device such as, but not limited to, an e-mail computer program, a web browser program, a file transfer protocol program, or a fax program. If required the communications utility 70 can be the essential software of, but not limited to, an e-mail program, a web browser program, a file transfer protocol program, or a fax program.

A preferred embodiment of the digital works and royalty distribution method is shown in FIG. 2. Item 120 is a marketer. The digital rights owner 100 owns the copyright to the work 40.

Item 25 is a database. Microsoft Access or Excel are typical commercial database applications that can be used to create the database 25. Items 140 are usage logs that consist of brief amounts of information such as, but not limited to, the advertisement identifier 35 and the digital work identifier 45.

An auditor 110 typically, is a financial computer program, however it can also be a person such as an accountant, lawyer, the marketer 120 or other third party. Item 160 is money. Item 170 is royalty payments. Item 220 is a server that contains an EMF 10. Item 215 is the act of comparing information between the auditor 110 and the database 25.

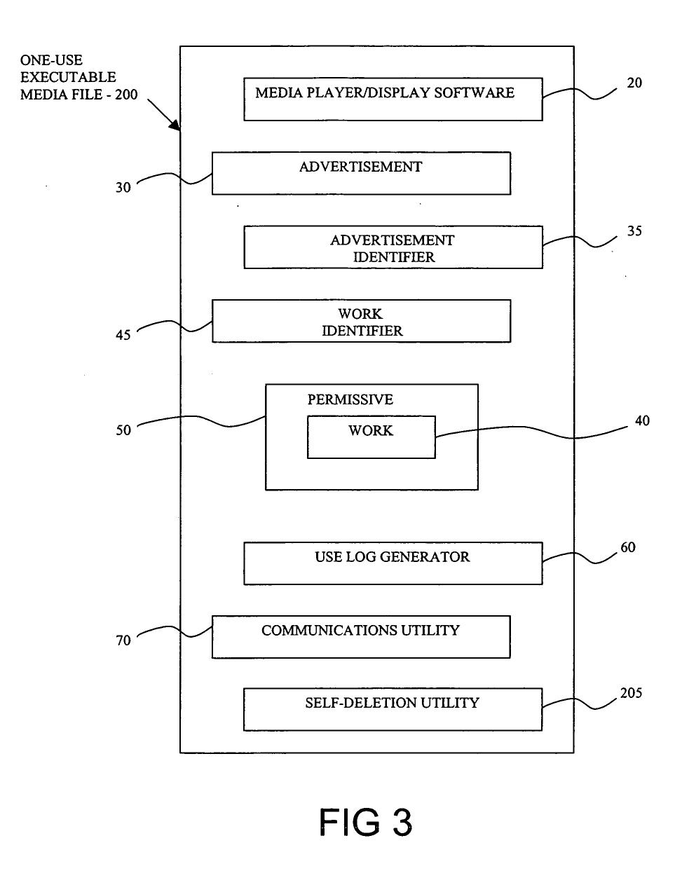

### FIG. 3—Alternative Embodiments

An additional embodiment, the One-Use Executable Media File 200, is shown in FIG. 3. This EMF contains a self-deletion utility 205. The self-deletion utility 205 consists of a delete, erase, remove or other similar command along with the file name and path of the intended target file, namely itself.

Advantages

From the description above, a number of advantages of my anti-piracy method for digital works become evident:
(a) Encoding the advertisements and works into one executable file makes them inseparable ensuring that the advertisement is viewed and/or heard. This allows marketers to offer free digital works to consumers since they will know that their advertisement can not be cut out of the file and discarded.
(b) When consumers are allowed to use free, high quality digital works, the profit incentive pirates of digital works currently have will be undermined, forcing them to relinquish the practice.
(c) The communications utility ensures the use log file is sent to the auditor so that the digital rights owner is reimbursed for the use of his/her work.
(d) Since the root cause of piracy is being addressed, the digital rights owner regains control of the revenue potential his/her digital work has.
   Operation—FIGS. 1, 2 and 3.

The process begins when a marketer 120 is willing to sponsor a work 40 belonging to a digital rights owner 100. An Executable Media file 10 is assembled by encoding together the marketer's advertisement 30, the digital rights owner's work 40, the advertisement identifier 35, the work identifier 45, the media player and/or display software 20 that is compatible with the work 40 and advertisement 30, the permissive 50, the use log generator 60 and the communications utility 70. This can be done by a person skilled in the art. The database 25 generates, issues and stores the advertisement identifier 35, and the work identifier 45 which are recalled prior to compilation of the EMF 10.

Once the EMF 10 has been compiled, it can reside on a server 220 for consumers 130 to download 150. Consumers 130 can also distribute copies 155 of it directly to acquaintances. Assuming the consumer 130 downloaded the EMF 10 to a personal computer with a Microsoft Windows operating system, then he/she can start or run it by selecting the file in Windows Explorer and then press the Enter or Return key on their keyboard. Other standard ways of starting a program in Windows can also be used to start an EMF 10.

Once started the media player and/or display software 20 is initiated and plays and/or displays the advertisement 30. After an advertisement 30 has been played and/or displayed, the EMF 10 invokes the permissive 50, which performs a conditional check to ensure the advertisement 30 was played and/or displayed first, before allowing the media player and/or display software 20 to play and/or display the work 40. The permissive 50 can also be used to allow access to only a portion of the work 40. For example if the EMF contains two fifteen second advertisements 30 and eight minutes of work 40, then the permissive 50 can allow access to the first four minutes of work if only one advertisement was played. The permissive 50 can then grant access to the next four minutes of the work after the second commercial has been played. Once access to a portion of the work 40 has been granted, it can remain accessible to the consumer 130 until the EMF 10 is closed or terminated.

EMF's containing movies or shows can be made to allow a consumer to view all the advertisements before viewing the work or view half the advertisements and grant access to half the work. To gain access to the second half of the work, the remaining half of the ads must be viewed first. EMF's can also be made to act like television broadcasts whereby the ads are viewed at regular intervals during the work. Each advertisement period is required to be played before the permissive grants access to the remainder of the work. After the permissive 50 grants access to the work 40, the use log generator 60 generates a use log 140. The use log 140 will contain the advertisement identifier 35 and the work identifier 45, and can reside on the consumer's device until it is sent to the auditor 110 by the communications utility 70.

Once the use log 140 is ready to be sent to the auditor 110, the communications utility 70 is called upon to begin a communications program on the consumer's computer, such as an e-mail program. The communications utility 70 will fill in the auditor's 110 address, attach or paste the use log 140 information to the e-mail and then send the message. EMF's can be made to work on devices such as mobile phones whereby the communications utility 70 will initiate the text or e-mail features of the phone.

The auditor 110, will control how money 160 from the marketer 120 are paid to the digital rights owner 100. The marketer 120 will normally deposit money 160 in an account with the auditor 110. When the use log 140 is received, the auditor 110 compares 215 the advertisement identifier 35 and the work identifier 45 contained in the file to those stored in the database 25. Money 160 is then transferred from the marketer 120 to the digital rights owner 100 in the form of royalty payments 170.

Some EMF's may require a very large amount of device memory, depending on the size of the work(s) incorporated and/or may be used infrequently by a consumer. In this case, a One-Use Executable Media file 200 can be created. The One-Use Executable Media file 200 is similar to a typical EMF 10 except it incorporates a self-deletion utility 205. When a One-Use Executable Media file 200 is closed or terminated, the self-deletion utility 205 identifies where the file is on the user's device and executes a delete or similar command to remove the file.

Conclusion, Ramifications, and Scope

Accordingly, the reader will see that the Executable Media File of this invention can be used to subvert the profit incentive pirates have when pirating digital works and can be used to provide consumers with free high quality digital works that are endorsed for use by the digital rights owner. In addition, since use of an EMF is paid for by advertisers, the value of a copyright owner's catalog of digital works will increase since payment is ensured. Furthermore, the EMF has the additional advantages in that
they allow consumers to customize what works are contained therein to suit his/her preferences;
they can be made to work on any platform;
they can be exchanged with others;
they allow marketers to have their advertisements played and/or displayed instead of removed and discarded.

While my above description contains many specificities, these should not be construed as limitations on the scope of the invention, but rather as an exemplification of one preferred embodiment thereof. Many other variations are possible. For example, an identifier can be used to identify the completed EMF instead of using a separate identifier to identify the work and another to identify the advertisement. A separate redundant communications utility program can also be created and made to reside in the RAM of a consumer's device. The communications utility program would always remain active during the consumer's session. Its purpose would be to detect and transmit use log files that could not be transmitted to the auditor when a communications link was unavailable. Moreover, the permissive can be made to verify a use log was generated correctly and it could also be made to ensure that an active communications link is available before granting access to the work.

Accordingly, the scope of the invention should be determined not by the embodiments illustrated but by the appended claims and their legal equivalents.

I claim:

1. A method of subverting the incentive to profit from the piracy of digital works consisting of:
(a) digital work(s);
(b) advertisement(s);
whereby consumers are allowed to use, at no cost to them, said digital work(s), and
whereby the use of said digital work(s) is paid for by said advertisement(s).

2. Executable Media files, comprising:
(a) media player and/or display means;
(b) digital work(s);
(c) advertisement(s);
whereby said media player and/or display means, said digital work(s) and said advertisement(s) are encoded into an executable software file making them inseparable.

3. The Executable Media file claimed in claim 2, further comprising:
permissive means that prevents the use in whole or in part of said digital work(s) until after said advertisement(s) have been played and/or displayed.

4. The Executable Media file claimed in claim 3, further comprising:
use log generator means that documents the usage of said Executable Media file for auditing purposes.

5. The Executable Media file claimed in claim 3, further comprising:
self-deletion means to remove said Executable Media file from a device's memory when usage of said Executable Media file has been terminated.

6. The Executable Media file claimed in claim 5, further comprising:
use log generator means that documents the usage of said Executable Media file for auditing purposes.

7. The Executable Media file claimed in claim 4, further comprising:
communications means to convey said use log to a predetermined location for auditing purposes.

8. The Executable Media file claimed in claim 6, further comprising:
communications means to convey said use log to a predetermined location for auditing purposes.

9. A method for subverting the incentive to profit from the piracy of digital works comprising:
(a) the Executable Media file claimed in claim 7;
(b) auditor means;
whereby said Executable Media file generates a use log that is subsequently conveyed to said auditor means to permit royalty payment(s) to be issued to the copyright owner(s) of said digital work(s).

10. A method for subverting the incentive to profit from the piracy of digital works comprising:
(a) the Executable Media file claimed in claim 8;
(b) auditor means;
whereby said Executable Media file generates a use log that is subsequently conveyed to said auditor means to permit royalty payment(s) to be issued to the copyright owner(s) of said digital work(s).

11. A method for subverting the incentive to profit from the piracy of digital works comprising:
(a) the Executable Media file claimed in claim 4;
(b) auditor means;
(c) independent communications means;
whereby said independent communications means conveys the use log generated by said Executable Media file to said auditor means, to permit royalty payment(s) to be issued to the copyright owner(s) of said digital work(s).

12. A method for subverting the incentive to profit from the piracy of digital works comprising:
(a) the Executable Media file claimed in claim 6;
(b) auditor means;
(c) independent communications means;
whereby said independent communications means conveys the use log generated by said Executable Media file to said auditor means, to permit royalty payment(s) to be issued to the copyright owner(s) of said digital work(s).
